(19) United States
(12) Patent Application Publication
(10) Pub. No.: US 2025/0021809 A1
(43) Pub. Date: Jan. 16, 2025

(54) RESONATORS-BASED PROGRAMMABLE OPTICAL NEURAL NETWORKS

(71) Applicant: HEWLETT PACKARD ENTERPRISE DEVELOPMENT LP, Spring, TX (US)

(72) Inventors: YIWEI PENG, Spring, TX (US); Xian Xiao, Santa Barbara, CA (US); Yuan Yuan, Milpitas, CA (US); Stanley Cheung, Milpitas, CA (US); Sean Hooten, Milpitas, CA (US); Thomas Van Vaerenbergh, Diegem (BE); Marco Fiorentino, Milpitas, CA (US); Zhihong Huang, Milpitas, CA (US)

(21) Appl. No.: 18/487,452

(22) Filed: Oct. 16, 2023

Related U.S. Application Data
(60) Provisional application No. 63/513,678, filed on Jul. 14, 2023.

(51) Int. Cl. G06N 3/067

(52) U.S. Cl. CPC G06N 3/0675

(57) ABSTRACT

Systems and methods are provided for devices and methods for implementing an optical neural network (ONN) by leveraging resonator structures, such on micro-ring resonators (MRRs). Examples include unit cells configured to perform a linear transformation on optical signals. Each unit cell comprises a plurality of signal mixing components optically coupled to between adjacent waveguides, where each signal mixing component corresponds to a distinct wavelength and is configured to mix optical signals on the adjacent waveguides at the distinct wavelength. Each unit cell also includes a plurality of phase tuning components each corresponding to a distinct wavelength and configured to adjust a phase of a mixed optical signal at the distinct wavelength.

### CROSS-REFERENCE TO RELATED APPLICATIONS

This application claims the benefit of and priority to U.S. Provisional Application No. 63/513,678, filed on Jul. 14, 2023, the contents of which is incorporated herein by reference in its entirety.

### BACKGROUND

Artificial neural networks (“ANNs”) have become a substantial tool for machine learning. ANNs benefit from application in a wide range of fields, such as, but not limited to, image recognition, natural language processing, and gaming, among others. For more complicated tasks, larger and deeper ANNs are becoming more important. These larger and deeper ANNs require faster and more energy-efficient computing hardware.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 depicts a schematic block diagram of an unit cell in accordance with the presently disclosed technology.

FIG. 2 depicts an example implementation of a unit cell in accordance with the presently disclosed technology.

FIGS. 3A and 3B depict an example transmission response and phase response of a phase tuning component in accordance with an example implementation disclosed herein.

FIG. 4 depicts an example transmission response of a signal mixing component in accordance with an example implementation disclosed herein.

FIG. 5 depicts another example implementation of a unit cell in accordance with the presently disclosed technology.

FIG. 6 depicts yet another example implementation of a unit cell in accordance with the presently disclosed technology.

FIG. 7 depicts another example transmission response of a signal mixing component in accordance with an example implementation disclosed herein.

FIG. 8A depicts a schematic diagram of an optical system for performing multiple matrix-vector multiplication in accordance with an example implementation disclosed herein.

FIG. 8B depicts a schematic representation of a multiple matrix-vector multiplication operation that can be performed by the optical system of FIG. 8A.

FIG. 9A depicts a schematic diagram of an optical system for performing multiple matrix-vector multiplication on a set of inputs in accordance with an example implementation disclosed herein.

FIG. 9B depicts a schematic representation of a multiple matrix-vector multiplication operation on a set of inputs that can be performed by the optical system of FIG. 9A.

FIG. 10A depicts a schematic diagram of an optical system for performing general matrix multiplication in accordance with an example implementation disclosed herein.

FIG. 10B depicts a schematic representation of a general matrix multiplication operation that can be performed by the optical system of FIG. 10A.

FIG. 11 is an example computing component that may be used to implement an optical neural network in accordance with the implementations disclosed herein.

FIG. 12 is an example computer system that may be used to implement optical neural network of the present disclosure.

The figures are not exhaustive and do not limit the present disclosure to the precise form disclosed.

### DETAILED DESCRIPTION

Examples of the presently disclosed technology provide for devices and methods for implementing an optical neural network (ONN). Examples disclosed herein provide optical devices, systems and methods that can be implemented for fully-connected layers in an ONN based on micro-ring resonators (MRRs). The present disclosure provides unit cells comprising one or more MRRs that can be implemented to perform linear transformations according to weights of a trained ONN. Each unit cell can be coupled between two adjacent waveguides. Each unit cell comprises signal mixing components for mixing optical signals propagating on the two adjacent waveguides and phase tuning components for adjusting a phase of the resulting mixed optical signal. The mixing and phase tuning can be adjusted to achieve a desired linear transformation.

As alluded to above, ANNs can be a tool for machine learning (ML). As ANNs become larger and deeper, they require faster and more energy-efficient computing hardware. Specifically designed computing hardware platforms, such as graphical processing units (GPUs) and tensor processing units (TPUs), have been developed to address this growing demand for computation resources. However, conventional electronic ANNs have several limitations, including high-energy consumption, limited processing speed, and susceptibility to electromagnetic interference. As a result, ONNs have drawn increasing interest because they rely on light to perform computations and processing, rather than electronic signals. The reliance on light can overcome the above bottlenecks of electronic ANNs. For example, ultra-high-speed optoelectronic devices, such as photodiodes and modulators, can enable operation rates that are one to two orders of magnitude higher than electronic counterparts. Further, the reliance on light can provide ONNs that are resistant to electromagnetic interference, have no length-dependent resistance, and consume low energy. Thus, ONNs have been recognized as a competitive solution due to ONNs offering energy-efficient, compact, and high-speed ML accelerators.

A component of ANNs are fully-connected (FC) layers. FC layers are abstraction layers of a neural network in which each neuron applies a linear transformation to an input vector through a weights matrix. As a result, all possible connections from one layer to the next layer are present, such that every input of an input vector into the one layer can influence every output of an output vector from the next layer.

In ONNs, FC layers can be realized by programmable photonic circuit architectures. Conventionally, Mach-Zehnder Interferometers (MZIs) have been used as building blocks for these programmable photonic circuits. In this case, each MZI can provide arbitrary control over power splitting ratio and relative phase shift between input and output ports of the MZI by varying relative phase between branches of the MZI. By cascading MZIs in a mesh fabric, the MZI mesh can be used to perform complex ML tasks. However, the driving power of an MZI can be relatively high. For example, dynamic power consumed to train an MZI based ONN can be 200 fJ/bit per MZI, while static power consumption, after training, can be 30 mW per MZI. Additionally, the footprint of such photonic circuits can be relatively large, generally several hundreds of μm or more in length. As a result, footprint and power consumption considerations impact fabrication of high-density ONNs that utilize MZIs. As ONNs become larger and deeper, the density increases, which results in larger device footprints and increased power consumption.

Accordingly, implementations of the present disclosure provide optical devices that can be used as building blocks of a programmable photonic circuit architecture for implementing ONNs, such as but not limited to, FC layers. As alluded to above, the present disclosure provides optical devices that utilize MRR based unit cells. These unit cells comprise one or more MRRs that are configured to perform linear transformations on optical signals at a plurality of wavelengths according to a weight matrix of a trained neural network. Relative to MZI based approaches, the unit cells disclosed herein consume less power. For example, dynamic power consumption during training may be on the order of tens of fj/bit (e.g., 10 fj/bit) per MRR and static power consumption after training may be on the order single digits of mW (e.g., 4 mW) per MRR. Thus, the unit cells according to the present disclosure can enable a wide range of applications and different matrix operations performed by the ONN.

In an example implementation, a unit cell can comprise a plurality of sub-unit cells optically coupled between adjacent waveguides. Each sub-unit cell comprises a signal mixing component and a phase tuning component, such that the unit cell comprises a plurality of signal mixing components and a plurality of phase tuning components. The plurality of signal mixing components can be configured to mix optical signals propagating on each of the adjacent waveguides for a plurality of wavelengths of light. The plurality of phase tuning components can be configured to adjust a phase of the mixed optical signal for the plurality of wavelengths. Each sub-unit is configured to operate on a distinct wavelength of light. As such, a signal mixing component and a phase tuning component of a given sub-unit are configured to operate on the corresponding distinct wavelength of light. Thus, a number of optical signals can be encoded onto the plurality of wavelengths included in a single input signal, such that each optical signal propagates at a different wavelength.

As used herein, “optically coupled” refers to an interconnection between devices to transfer an optical signal or a portion of the optical signal from one device to another. In various examples, optical coupling can be achieved by an optical coupler, such as, but not limited to, a directional couplers, through optical splitters, and the like. A directional coupler may comprise of two or more waveguides positioned close together so that light may can be evanescently transferred (e.g., by evanescent coupling) from one waveguide to another waveguide.

According to various examples of the presently disclosed technology, each phase tuning component can be provided as an MRR optically coupled to a waveguide of the adjacent waveguides. The MRR of a respective sub-unit cell can be configured to resonate at a wavelength corresponding to that sub-unit cell. A phase shifting mechanism can be coupled to the MRR and tuned so to change a refractive index of the MRR, which can be selectively controlled to vary the phase and tune the resonance of the MRR. The phase change induced by the phase shifting mechanism may be tuned so to apply a weight of a trained weight matrix to perform a linear transformation on the optical signal of a wavelength corresponding to the sub-unit. The phase shifting mechanism may be implemented as a mechanism or device that provides for thermal-optical tuning (e.g., a resistive heater coupled that generates heat based on an applied voltage), electro-optical tuning (e.g., a PN diode), metal-oxide-semiconductor capacitor (MOSCAP) tuning, or the like. Examples of a MOSCAP are provided, for example, in U.S. Pat. No. 9,612,503; U.S. patent application Ser. No. 17/972,927; and U.S. patent application Ser. No. 18/175,970, the disclosures of which are incorporated herein by reference in their entirety.

Signal mixing components, according to the present disclosure, may receive optical signals propagating on the adjacent waveguides, mix the optical signals, and output mixed, optical signal onto the adjacent waveguides, which can be used downstream. Through mixing of input optical signals for outputting onto the adjacent waveguides, each signal input into the unit cell can influence each output of the unit cell. The ratio of the mixture of the optical signals output from the unit cell can be controlled according to weights of a trained weights matrix to perform the linear transformation.

The signal mixing components may be implemented in a variety of ways. A few illustrative examples are provided herein, but other implementations are possible. In one example, a signal mixing component can be provided as a serially coupled double ring MRR having a first MRR optically coupled to a first waveguide and a second MMR optically coupled to the first MRR. The second MMR can also be optically coupled to a second waveguide that is adjacent to the first waveguide. The first and second MRRs have resonances at a common wavelength that is distinct to a respective sub-unit cell and different among the plurality signal mixing components that make up the unit cell. In another example, a signal mixing component comprises an MRR optically coupled to the first waveguide and optically coupled to the second waveguide via a contra-directional coupler. In yet another example, the second waveguide includes a plurality of waveguide crossings and a sub-unit cell comprises a MRR optically coupled to the first waveguide and to a distinct waveguide crossing of the plurality of waveguide crossings.

In each implementation of the signal mixing components, the MRRs that make up a signal mixing component may comprise phase shifting mechanisms that can be tuned to ensure that the resonance of the MRRs matches a wavelength corresponding to the sub-unit cell so to optically couple optical signal propagating on each waveguide at a corresponding wavelength into the signal mixing component, mix the optical signals, and optically couple mixed optical signals onto the waveguides. However, in some cases, the phase shifting mechanisms may dominate the energy consumption of the unit cell and, in the case of a double MRR structure, may complicate the tuning as both MRRs may need to be individually tuned to match. Thus, the implementations of signal mixing components comprising fewer MRRs may be utilized to reduce the number of phase shifting mechanism, which translates to reduced energy consumption and reduced complexity in operation.

In some examples according to the present disclosure, a ONN can be implemented as a MRR based mesh fabric comprising a plurality of cascaded unit cells, as described above. As a result of the MRR based unit cells according to the present disclosure, a mesh fabric can be achieved having a footprint that is at least 10 times smaller than the conventional MZI based approach, where a MZI based unit cell may be 100 μm by 400 μm. In the MRR based mesh fabric, a plurality of waveguides can be provided and building blocks or unit cell comprising a plurality of signal mixing components and a plurality of phase tuning component are optically coupled between adjacent waveguides. The MRR-based unit cells can incorporate wavelength-division multiplexing (WDM) techniques, which enable multiplication with different matrices, through sub-unit cells configured for distinct wavelengths of light. This approach can be leverage to decrease computation time through increased computation speeds of matrix multiplication functions of an ONN, while also providing for ONNs of increased density with reduced footprints. Moreover, by using WDM and exploiting multiple free spectral ranges (multi-FSRs) of the MRRs, matrix-vector multiplications (MVMs) of a single photonic core can be extended into multiple general matrix multiplication (GEMM) operations by parallel processing within a single optical device.

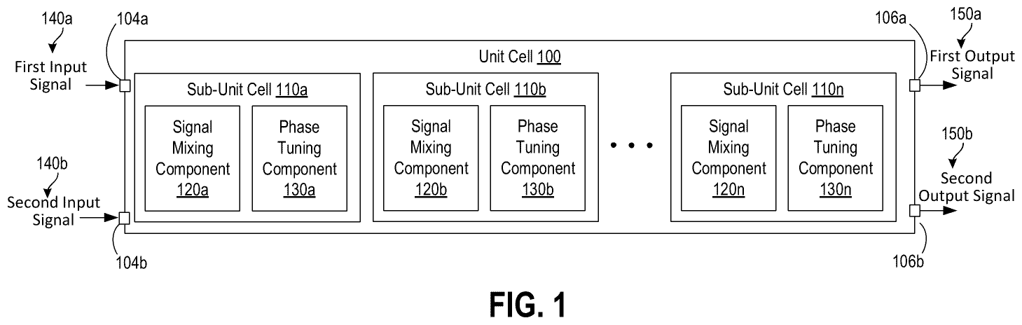

FIG. 1 depicts a schematic block diagram of a unit cell 100 in accordance with the presently disclosed technology. Unit cell 100 can receive a first input signal 140a via a first input port 104a and a second input signal 140b via a second input port 104b. Each of the first and second input signals 140a and 140b may comprise a plurality of optical signals propagating at a plurality of wavelengths of light. In various examples, first input signal 140a and second input signal 140b comprise the same plurality of wavelengths of light. Each optical signal of each wavelength for the first input signal 140a and second input signal 140b may be encoded with information. For example, an optical signal of a first wavelength of first input signal 140a may be encoded with first information (e.g., data of a first element of a vector or matrix), an optical signal at a second wavelength of light of first input signal 140a may be encoded with second information (e.g., data of a second element of a vector or matrix), and so on. Similarly, an optical signal at a first wavelength of light of second input signal 140b may be encoded with the first information (e.g., data of a first element of a vector or matrix), an optical signal at a second wavelength of light of second input signal 140b may be encoded with the second information (e.g., data of a second element of a vector or matrix), and so on. The unit cell 100 can be configured to apply a weight to the information encoded onto first and second input signals 140a and 140b by mixing the input signals and tuning a phase of the mixed signal according to a trained weight programmed into the unit cell 100. The weighted information, as a result of the mixing and phase tuning, can be encoded on the resulting output signals, which is output from first output port 106a as first output signal 150a and second output port 106b as second output signal 150b.

Unit cell 100 comprises a plurality of sub-unit cells 110a-110n (individually referred to herein as a sub-unit cell 110 as an illustrative example or collectively referred to herein as sub-unit cells 110). The sub-unit cells 110 comprise signal mixing components 120a-120n (individually referred to herein a signal mixing component 120 as an illustrative example or collectively referred to herein as signal mixing components 120) and phase tuning components 130a-130n (individually referred to herein as a phase tuning component 130 as an illustrative example or collectively referred to herein as phase tuning components 130). For example sub-unit cell 110a includes a signal mixing component 120a and a phase tuning component 130a, sub-unit cell 110b includes a signal mixing component 120b and a phase tuning component 130b, and so on.

The signal mixing components 120 can be configured to mix first and second input signals 140a and 140b. Each sub-unit cells 110 can be associated with a distinct wavelength of light of the plurality of wavelengths. The signal mixing components 120 of a respective sub-unit cells 110 can be configured to mix an optical signal of first input signal 140a of the associated wavelength with an optical signal of second input signal 140b of the same wavelength. For example, sub-unit cell 110a may be associated with a first wavelength of light, and sub-unit cell 110b may be associated with a second wavelength of light. First and second input signals 140a and 140b each comprise information encoded on the first wavelength and information encoded onto the second wavelength. Signal mixing component 120a can be configured to mix optical signals from first and second input signals 140a and 140b that propagate at the first wavelength, and signal mixing component 120b can be configured to mix optical signals from first and second input signals 140a and 140b that propagate at the second wavelength.

The phase tuning components 130 can be configured to adjust a phase of the mixed input signals 140a and 140b for each respective wavelength of the plurality of wavelengths. Each phase tuning component 130 can be configured to operate on a wavelength of light associated with a respective one of the sub-unit cells 110. With reference to the above example, phase tuning component 130a can be configured to adjust a phase of a mixed signal, which is output from the signal mixing component 120a, at the first wavelength. Phase tuning component 130b can be configured to adjust a phase of a mixed signal, which is output from the signal mixing component 120b, at the second wavelength.

As a result, a number of input optical signals can be encoded onto the plurality of wavelengths included in the input signals 140a and 140b, such that each optical signal propagates at a different wavelength corresponding to a given signal mixing component 120 and a given phase tuning component 130. The phase tuning components 130 can be used to control the relative phase differences among different ports (e.g., second input port 104b and first input port 104a) independently, the signal mixing components 120 can be implemented to connect and mix signals of the different ports.

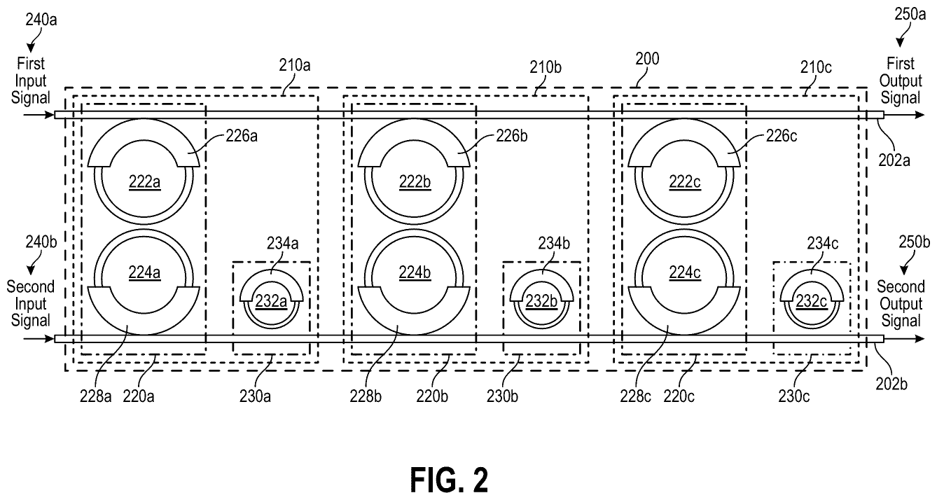

FIG. 2 depicts an example implementation of a unit cell in accordance with the presently disclosed technology. FIG. 2 depicts unit cell 200, which is an example implementation of unit cell 100. Unit cell 200 comprises a plurality of sub-unit cells, illustratively shown as sub-unit cell 210a through sub-unit cell 210c (individually referred to herein as a sub-unit cell 210 as an illustrative example or collectively referred to herein as sub-unit cells 210). Sub-unit cell 210a through sub-unit cell 210c comprise signal mixing component 220a through signal mixing component 220c (individually referred to herein as a signal mixing component 220 as an illustrative example or collectively referred to herein as signal mixing components 220) and phase tuning component 230a through phase tuning component 230c (individually referred to herein as a phase tuning component 230 as an illustrative example or collectively referred to herein as phase tuning components 230). Signal mixing components 220 and phase tuning components 230 are example implementations of signal mixing components 120 and phase tuning components 130, respectively. While three sub-unit cells 210 are shown in FIG. 2, this is for illustrative purposes only. Any number of sub-unit cells 210 may be included in unit cell 200.

Unit cell 200 is optically coupled between adjacent waveguides, shown as first waveguide 202a and second waveguide 202b (individually referred to herein as a waveguide 202 or bus waveguide 202 as an illustrative example or collectively referred to herein as waveguides 202 or bus waveguides 202). Waveguides 202a and 202b may be formed of semiconductor material, such as silicon or other Group IV material or Group III-V material. First and second input signals 240a and 240b can be injected into the first and second waveguides 202a and 202b, respectively. The first and second input signals 240a and 240b may be substantially similar to first and second input signals 140a and 140b. As such, first and second input signals 240a and 240b comprise a plurality of optical signals propagating at a plurality of wavelengths, where each optical signal is encoded with information. First and second output signals 250a and 250b are output from first and second waveguides 202a and 202b, respectively.

Sub-unit cells 210 can be implemented as resonator structures. For example, signal mixing component 220a comprises a first resonator structure 222a optically coupled to first waveguide 202a and a second resonator structure 224a optically coupled to second waveguide 202b. The first resonator structure 222a is optically coupled to the second resonator structure 224a. The configuration of first resonator structure 222a and second resonator structure 224a can be referred to as a serially coupled double resonator structure. In the case of signal mixing component 220b (or signal mixing component 220c), first resonator structures 222b (or first resonator structure 222c) and second resonator structures 224b (or second resonator structure 224c) are optically coupled together and optically coupled to the first waveguide 202a and second waveguide 202b, respectively. First resonator structures 222a-222c are individually referred to herein as a resonant structure 222 as an illustrative example or collectively referred to herein as first resonator structures 222. Second resonator structures 224a-224c are individually referred to herein as a resonate structure 224 as an illustrative example or collectively referred to herein as second resonator structures 224. In the example of FIG. 2, the resonator structures 222 and 224 are provided as MRRs forming serially coupled double ring MRR structures.

Like the signal mixing components 220, the phase tuning components 230 comprise at least one resonator structure optically coupled to second waveguide 202b. For example, phase tuning components 230a-230c comprise a resonator structure 232a, resonator structure 232b, and resonator structure 232c (individually referred to herein as a resonate structure 232 as an illustrative example or collectively referred to herein as resonator structures 232), respectively, optically coupled to the second waveguide 202b. In various examples, a respective resonator structure 232 of a given phase tuning component 230 is optically coupled to second waveguide 202b downstream of a corresponding signal mixing components 220. In the case of FIG. 2, the phase tuning component 230a is positioned between the comprising signal mixing component 220a and a signal mixing component 220b. However, a phase tuning component 230a may be positioned downstream of the signal mixing component 220b, according to some implementations.

As described above, the resonator structures 222, 224, and 232 may be implemented as MRRs, in some examples, or other optical ring resonator. A resonator structure may be a closed loop waveguide formed of semiconductor material, such as silicon or other Group IV material. The shape of the loop may be, for example, but not limited to, circular, elliptical, a obound shape, etc., thereby forming a resonator structure. A resonator structure may have an initial resonance wavelength (A) defined by the circumference length of the resonator structure (e.g., a radius in the case of an MRR). A resonator structure also comprises a plurality of resonance frequencies separated by an integer number of FSRs of the resonator structure (e.g., λ+(k−1)Δλ, where k is a non-zero integer).

In various examples, the resonator structures 222, 224, and 232 evanescently couple to another waveguide (e.g., a bus waveguide or another resonator structure) by use of a directional coupler. In the case of evanescent coupling, the amount of light optically coupled into one waveguide to another is based on a distance between the waveguides and a resonance frequency of the resonator structure. The amount of light optically coupled can be represented by a coupling coefficient or coupling ratio. The distance between waveguides can be controlled so to bring one waveguide as close as possible to another waveguide. The coupling length represents an effective curve length of the resonator structure for the coupling phenomenon to happen with the waveguide, which can be based on a radius of curvature of the resonator structure where the evanescent coupling is to occur. In the case of FIG. 2, the radius of the MRR structures may be designed to achieve a desired curve length for a desired resonance frequency. The resonance frequency is also dependent on effective refractive indices between the waveguide and the optical ring resonator.

An input optical signal can be optically coupled into and out of a resonator structure based on the resonance frequency of the resonator structure. For example, an input optical signal propagating at a wavelength aligned with a resonance frequency of the resonator structure can be optically coupled into the resonator structure, while other wavelengths are agnostic to the resonator structure. Thus, the resonance frequency of resonator structures included in the sub-unit cells 210 may be tuned to configure each of the sub-unit cell 210 to operate on a distinct wavelength of light, thereby associating a distinct wavelength of light to each sub-unit cell 210.

For example, in the case of FIG. 2, first input signal 240a and second input signal 240b may include optical signals propagating at a first wavelength, a second wavelength, and a third wavelength. The resonance frequency of resonator structures 222a, 224a, and 232a of sub-unit cell 210a may be aligned with the first wavelength. Thus, optical signals at the first wavelength can be optically coupled into and output from the first resonator structure 222a and second resonator structure 224a, as well as the resonator structure 232a. Similarly, the resonance frequency of resonator structures 222b, 224b, and 232b may be aligned with the second wavelength, such that optical signals at the second wavelength can be optically coupled into and output of the resonator structures 222b, 224b, and 232b. Likewise, the resonance frequency of resonator structures 222c, 224c, and 232c may be aligned with the third wavelength, such that optical signals at the third wavelength can be optically coupled into and output of the resonator structures 222c, 224c, and 232c.

For a given phase tuning component 230, the electric field transmission function (T_{PT_Double_MRR}) of an optical signal input into the resonator structure 232 from second waveguide 202b and an optical signal output onto the waveguide second waveguide 202b after passing through the resonator structure 232 is provided below.

$${T}_{PT} = \frac{t - {ae}^{j θ}}{1 - {tae}^{j θ}} \qquad Eq . 1$$

where a is the single round trip amplitude transmission in the resonator structure, which is determined based on the material of the waveguide forming the resonator structure and bending losses in the resonator structure; t is the transmission coefficient, which is based on to the coupling coefficient (kₚₜ) between resonator structure 232 and second waveguide 202b as t²+kₚₜ²=1; θ is the phase of the light propagating in the resonator structure; and j is an imaginary number. The phase (θ) of light in the resonator structure can be provided as θ=2πfn(L/c), where f represents the resonance frequency, n is refractive index of the resonator structure; L is the circumference length of the resonator structure; and c is the speed of light.

The resonator structure 232 can be tuned on/off resonance by varying the phase θ, which can be achieved by changing the refractive index of the waveguide forming the resonator structure 232. Resonator structures 232a-232c can include phase shift mechanisms 234a-234c (individually referred to herein as a phase shift mechanism 324 as an illustrative example or collectively referred to herein as phase shift mechanisms 234) disposed thereon, respectively configured to alter the effective index of refraction of a waveguide of the respective resonator structure 232. The phase shifting mechanisms 234 can be implemented through thermal-optical tuning (e.g., a resistor coupled to the waveguide that generates heat based on an applied voltage), electro-optical tuning (e.g., coupling a PN diode to the waveguide), metal-oxide-semiconductor capacitor (MOSCAP) tuning, or the like. Phase shifting mechanisms 234 can be independently or collectively controlled, as described below, to alter the effective refractive index of a respective resonator structure, thereby tuning the resonance of the respective resonator structure.

The phase tuning components 230 may operate in an over-coupled regime. For example, the resonator structure 232 may be over-coupled to second waveguide 202b. As used herein “over-coupled” refers to evanescent coupling between waveguides having a relatively high coupling coefficient (k). The coupling coefficient (k) is a value between 0 and 1, where a value of 1 expresses perfect or 100% coupling of light from one waveguide to another waveguide. A high coupling coefficient may be, for example, a power coupling coefficient (k²) that is greater than the single round trip loss (1−a²) in the resonator structure 232 (e.g., k²>1−a² or tea). In an example implementation, k² is set as 0.2 (e.g., k is approximately 0.45) and a is 0.953 (e.g., a²=0.907). Any coupling coefficient is possible as long as it satisfies the above conditions. As discussed above, the coupling coefficient is dependent upon the distance between waveguides, as well as the resonance frequency of the resonator structure 232.

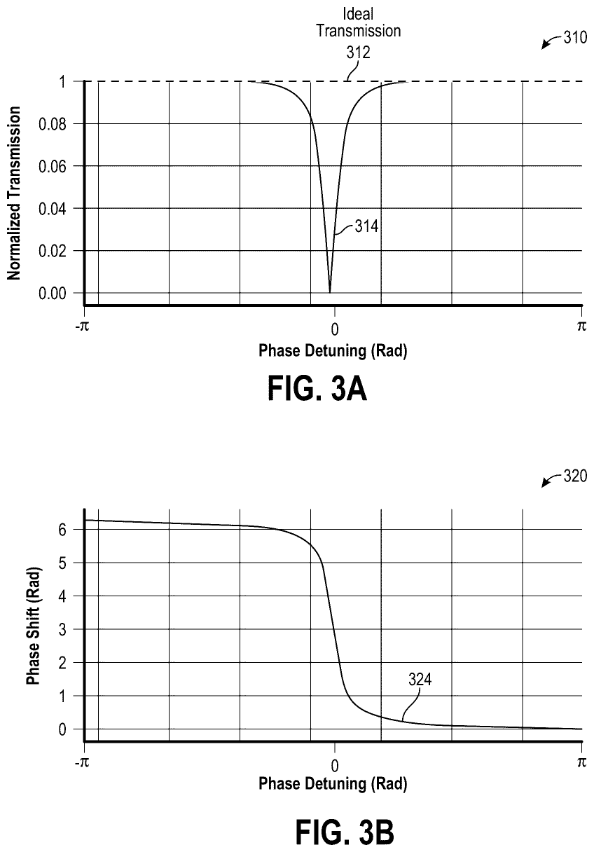

FIGS. 3A and 3B depict an example transmission response and phase response of a phase tuning component in accordance with an example implementation disclosed herein. FIG. 3A shows a transmission response plot 310 and FIG. 3B shows a phase response plot 320 at the output of an example phase tuning components 230, where a normalized transmission and a phase shift in radians is plotted as a function of phase detuning in radians. The phase detuning refers to a detuning of the resonance frequency of a phase tuning component 230 by the phase shifting mechanism, while the phase shift refers to a change in the phase of the light in the resonator structure after tuning relative to the phase without tuning. Transmission response plot 310 depicts a transmission response 312 of an ideal all-pass filter, where the transmission response remains at unity. Transmission response plot 310 also depicts a transmission response 314 of an example implementation of a phase tuning components 230, where the coupling coefficient (k) of resonator structure 232 to the second waveguide 202b is approximately 0.45. Phase response plot 320 depicts a phase response 324 of the example implementation of phase tuning components 230. As can be seen from FIGS. 3A and 3B, a phase shift can be achieved by detuning phase tuning components 230, with minimal effect on the transmission (e.g., amplitude) of the output signal. In this example, the transmission loss is at most 5%.

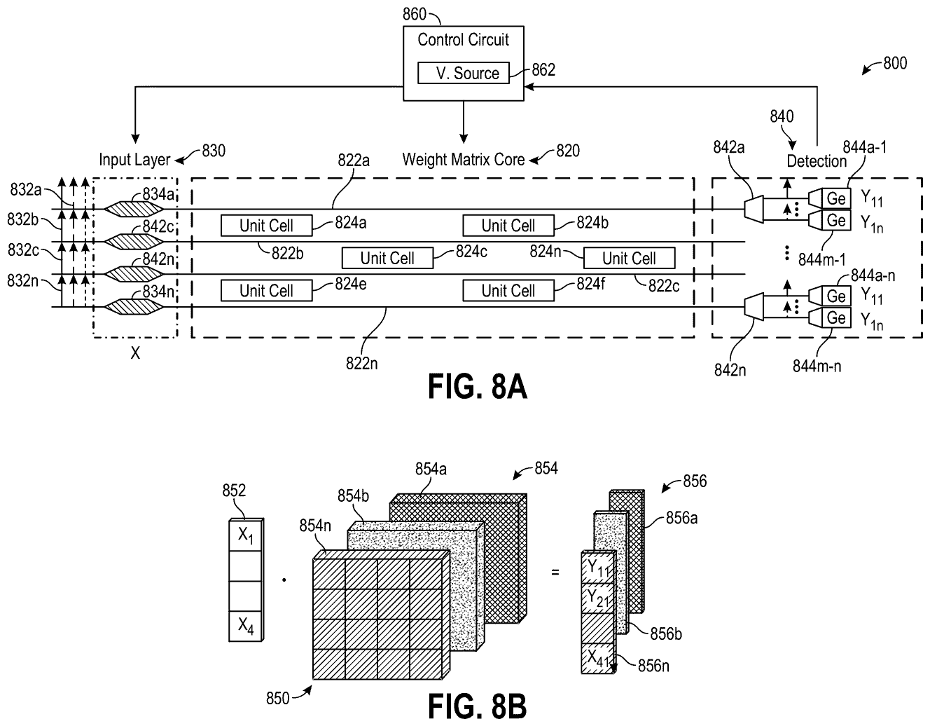

While the phase tuning components 230 can be used to control the relative phase differences among different waveguides independently, the signal mixing components 220 can be implemented to connect and mix signals from different waveguides. Referring back to FIG. 2, as described above, signal mixing components 220 can be implemented as a serially coupled double resonator structure. This configuration can be used to couple signals in different waveguides that propagate along a common direction and at a common wavelength, as well as enabling the cascading of multiple components with mesh setups for multiple-port linear transformation, as described below in connection with FIGS. 8A, 9A, and 10A, while keeping the bus waveguide straight without a need for waveguide bend or crossing.

Referring back to FIG. 2, in an example implementation, resonator structures 222 and resonator structures 224 of a given signal mixing component 220 may be identical. For example, resonator structures 222 and resonator structures 224 may have the same circumference length, waveguide material, and resonance frequency. Resonator structures 222 and resonator structures 224 may have the same separation distance between its waveguide and first waveguide 202a and second waveguide 202b, respectively. As such, resonator structures 222 and resonator structures 224 may have the same coupling coefficient (k₀). The coupling coefficient between resonator structures 222 and resonator structures 224 (denoted as k₁) may be configured to provide a flat optical response from input to output, which means that resonator structures 222 couples to resonator structures 224 with minimal or no loss between input and output. If the optical response is not flat, a loss in the response may occur which can be difficult to tune. Thus, implementations disclosed herein utilize a coupling coefficient (k₁) that is as high as possible while maintaining a flat optical response. In an example implementation, k₁² is set as 0.013 (e.g., k₁ is approximately 0.114), which provides the flat optical response. The electric field transmission matrix (T_{MT_Double_MRR}) (also referred to as transfer matrix) of the example signal mixing components 220 of FIG. 2 is:

$$Eq . 2$$

$${T}_{MT \_ Double \_ MRR} [ \begin{matrix}\frac{\begin{matrix}{a}^{2} {t}_{2} {e}^{2 j θ} - {at}_{1} {e}^{j θ} - \\ {at}_{1} {t}_{0} {t}_{2} {e}^{j θ} + {t}_{0}\end{matrix}}{\begin{matrix}1 - {at}_{1} {t}_{2} {e}^{j θ} - {at}_{1} {t}_{0} {e}^{j θ} + \\ {a}^{2} {t}_{2} {t}_{0} {e}^{2 j θ}\end{matrix}} & \frac{- ja {k}_{1} {k}_{0} {k}_{2} {e}^{j θ}}{\begin{matrix}1 - {at}_{1} {t}_{2} {e}^{j θ} - {at}_{1} {t}_{0} {e}^{j θ} + \\ {a}^{2} {t}_{2} {t}_{0} {e}^{2 j θ}\end{matrix}} \\ \frac{- {jak}_{1} {k}_{0} {k}_{2} {e}^{j θ}}{\begin{matrix}1 - {at}_{1} {t}_{2} {e}^{j θ} - {at}_{1} {t}_{0} {e}^{j θ} + \\ {a}^{2} {t}_{2} {t}_{0} {e}^{2 j θ}\end{matrix}} & \frac{\begin{matrix}{a}^{2} {t}_{2} {e}^{2 j θ} - {at}_{l} {e}^{j θ} - \\ {at}_{1} {t}_{0} {t}_{2} {e}^{j θ} + {t}_{0}\end{matrix}}{\begin{matrix}1 - {at}_{1} {t}_{2} {e}^{j θ} - {at}_{1} {t}_{0} {e}^{j θ} + \\ {a}^{2} {t}_{2} {t}_{0} {e}^{2 j θ}\end{matrix}}\end{matrix} ]$$

where a is the single round trip amplitude transmission in the resonator structure, which is the same for resonator structures 222 and resonator structures 224; t is the transmission coefficient, such that t₂ represents a transmission coefficient between first waveguide 202a and resonator structures 222, t₁ represents a transmission coefficient resonator structures 222 and resonator structures 224, and to represents a transmission coefficient between second waveguide 202b and resonator structure 224; e is the phase of the light propagating in the resonator structures, which is controlled so to be the same for resonator structures 222 and resonator structures 224. In Equation 2, k₂ represents the coupling coefficient between first waveguide 202a and resonator structures 222 and k₁ represents the coupling coefficient between first waveguide 202b and resonator structure 224. As noted above, in some examples, the resonator structures 224 and 222 maybe substantially identical, in which case k₂ may be the same or approximately the same as k₀. However, implementations disclosed herein are not limited to identical resonator structures, and as such k₀ and k₂ may differ for different applications. For similar reasons, to and t₂ may be the same or different.

To control the phase θ, the refractive index of the waveguide forming the resonator structures 222 and resonator structures 224 can be altered by utilizing phase shift mechanisms, similar to phase shift mechanisms 234 discussed above. For example, first resonator structure 222a and second resonator structure 224a may comprise first phase shift mechanism 226a and second phase shift mechanism 228a, respectively, disposed thereon and resonator structures 222b and resonator structures 224b may comprise first phase shift mechanism 226b and second phase shift mechanism 228b, respectively, disposed thereon. Likewise, resonator structures 222c and resonator structures 224c may comprise first phase shift mechanism 226c and second phase shift mechanism 228c, respectively, disposed thereon. First phase shift mechanisms 226a-226c are collectively referred to herein as first phase shift mechanism 226 and second phase shift mechanisms 228a-228c are re collectively referred to herein as second phase shift mechanism 228. The phase shifting mechanisms 226 and 228 can be configured to alter an effective index of refraction of a waveguide of the respective resonator structure. The phase shifting mechanisms 226 and 228 can be implemented through thermal-optical tuning (e.g., a resistor coupled to the waveguide that generates heat based on an applied voltage), electro-optical tuning (e.g., coupling a PN diode to the waveguide), metal-oxide-semiconductor capacitor (MOSCAP) tuning, or the like. Phase shifting mechanisms 226 and 228 can be independently or collectively controlled, as described below, to alter the effective refractive index of a respective resonator structure, thereby tuning the resonance of the respective resonator structure. By tuning the resonance, the intensity (e.g., amplitude) of light coupled into and out of each resonator structure can be adjusted. In various examples, the resonance of each resonator structures 222 and resonator structures 224 can be tuned simultaneously to have the same transmission response to the detuning.

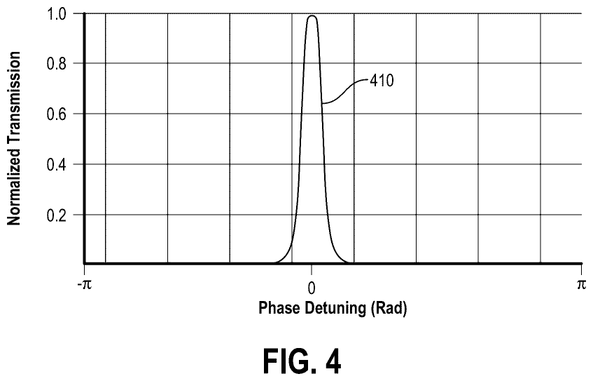

FIG. 4 depicts an example transmission response of a signal mixing component in accordance with an example implementation disclosed herein. FIG. 4 shows a transmission response plot 410 at the output of an example signal mixing component 220, where a normalized transmission is plotted as a function of phase detuning in radians. In this example, the coupling coefficient (k₁) between resonator structure 222 and resonator structure 224 is approximately 0.114. As can be seen from FIG. 4, signal mixing component 220 can be utilized to achieve any intensity transmission coefficients, from 0 to 1, through phase detuning (e.g., tuning of the resonance frequencies of resonator structure 222 and resonator structure 224), which can be utilized to implement unitary matrix using the unit cell 200.

While FIG. 2 depicts resonator structure 232 as smaller than 224 and/or resonator structures 222, this is for illustrative purposes only. The figures are not intended to be drawn to scale and the relative sizes between structures depicted in FIG. 2 (as well as other figures of the present disclosure) are not intended to be limiting. Thus, the circumference length of resonator structure 232 may be the same, larger, or smaller than resonator structures 224 and/or resonator structures 222, as desired for a given application. In an illustrative example, the circumference length of resonator structure 232 may be approximately the same as resonator structures 224 and/or resonator structures 222 so to resonant at the same frequency as resonator structures 224 and/or resonator structures 222. This permits resonator structure 232 to have the same resonance frequency as resonator structures 224 and/or resonator structures 222, thereby operating on the same wavelength of light.

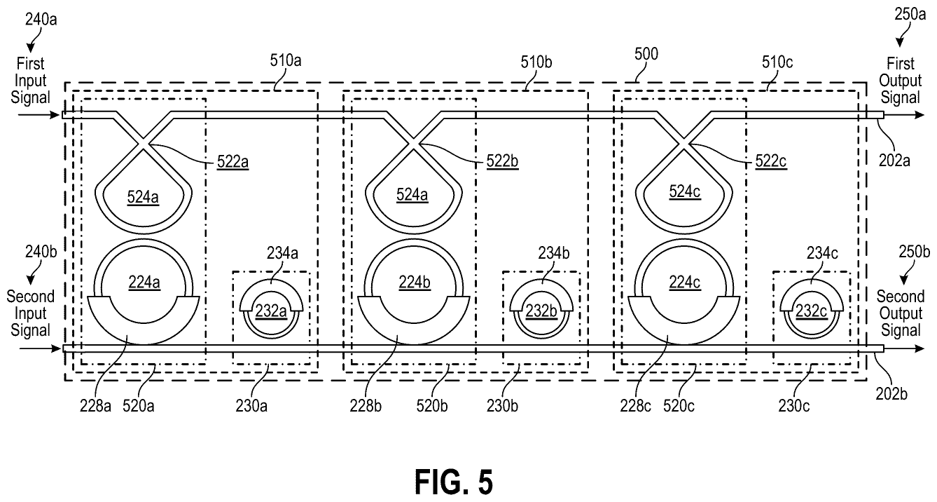

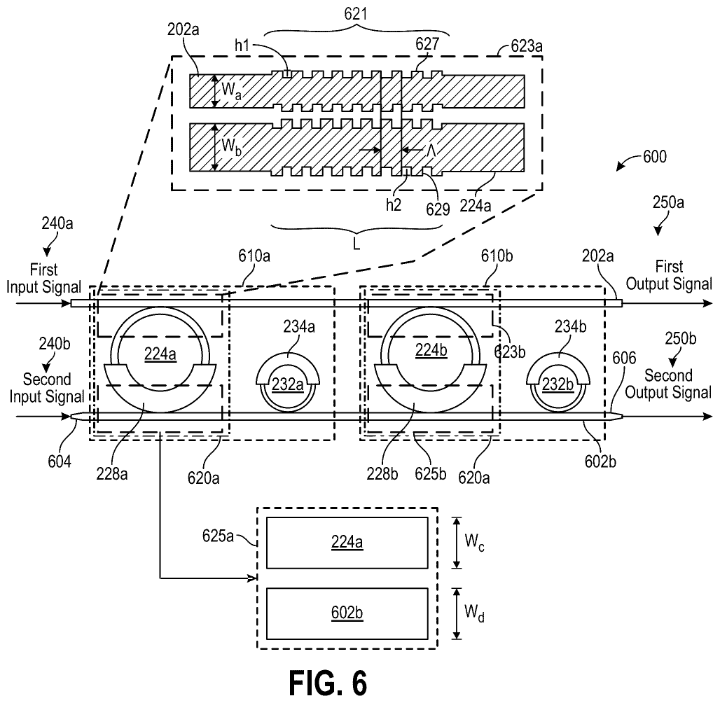

As alluded to above, phase shifting mechanisms may dominate the energy consumption of the unit cell 200. For example, when a phase shifting mechanism is implemented as a resistive heater for thermal-optical tuning, the energy consumption by the phase shifters represents the majority of the energy consumed by the unit cell 200, and thus dominates the energy consumption of a mesh network that implements unit cell 200. Accordingly, some implementation disclosed herein can be utilized to reduce the number of phase shifting mechanisms included in a unit cell, thereby reducing energy consumption of the unit cell. Example implementations are provided below in connection with FIGS. 5 and 6.

FIG. 5 depicts an example of another implementation of a unit cell in accordance with the presently disclosed technology. FIG. 5 depicts unit cell 500, which is substantially similar to unit cell 200 except as provided herein. Particularly, unit cell 500 provides a single resonator structure implementation of signal mixing components. Reference numbers in FIG. 5 refer to elements of like reference numbers from FIG. 2 and the description provided in connection with FIG. 2 applies here to like reference numbers in FIG. 5.

For example, unit cell 500 is optically coupled between first waveguide 202a and second waveguide 202b. First and second input signals 240a and 240b can be injected into the first and second waveguides 202a and 202b, respectively, and the first and second output signals 250a and 250b are output form first and second waveguides 202a and 202b, respectively.

Unit cell 500 comprises a plurality of sub-unit cells, illustratively shown as sub-unit cell 510a through sub-unit cell 510c (individually referred to herein as a sub-unit cell 510 as an illustrative example or collectively referred to herein as sub-unit cells 510). The sub-unit cells 510 each comprise a signal mixing component and a phase tuning component. For example, sub-unit cells 510a-510c comprise signal mixing component 520a through signal mixing component 520c (individually referred to herein as a signal mixing component 520 as an illustrative example or collectively referred to herein as signal mixing components 520) and phase tuning component 230a through phase tuning component 230c. While three sub-unit cells 510 are shown in FIG. 5, this is for illustrative purposes only. Any number of sub-unit cells 510 may be included in unit cell 500. As described above, the sub-unit cells 510 comprise resonator structures that can be tuned so to configure each sub-unit cell 510 to operate on a distinct wavelength of light, thereby associating a distinct wavelength of light to each sub-unit cell 510.

As noted above, each sub-unit cell 510 comprises phase tuning components 230 and the description of phase tuning components 230 provided in connection with FIG. 2 applies to FIG. 5. Thus, each of the phase tuning components 230 comprises a resonator structure 232 and a phase shift mechanism 234 disposed thereon. A respective phase tuning component 230 of a given sub-unit cell 510 can control the phase difference between optical signals, propagating at a wavelength corresponding to the given sub-unit cell 510, on first waveguide 202a and second waveguide 202b.

Each sub-unit cell 510 also comprises a signal mixing component 520, which may be substantively similar to the signal mixing components 220, except as provided herein. For example, signal mixing components 520a-520c comprise resonator structures 224a-224c, respectively, optically coupled to second waveguide 202b. In the example of FIG. 5, signal mixing components 520a-520c are also optically coupled to a reverse propagation coupling sections 524a-524c (individually referred to herein as a reverse propagation coupling sections 524 or coupling section 524 as an illustrative example or collectively referred to herein as reverse propagation coupling sections 524 or coupling sections 524), via waveguide crossings 522a-522c (individually referred to herein as a waveguide crossing 522 as an illustrative example or collectively referred to herein as waveguide crossings 522) of the waveguide 202a. A waveguide crossing refers to a continuous waveguide that includes a section of the waveguide that crosses over another section of the waveguide. The waveguide cross exhibit low loss, such that an optical signal in one section of the waveguide does not pass (or a negligible amount passes) into the other section of the waveguide.

For example, each waveguide crossing 522 is formed from first waveguide 202a and coupling section 524. Light on first waveguide 202a entering a waveguide crossing 522 propagates in a first direction and into coupling section 524, toward the output end of the unit cell 500. The first waveguide 202a is turned in a reverse direction (e.g., toward the input end of unit cell 500) at the coupling section 524. The coupling section 524 is brought as close as possible to a resonator structure 224 so to optically couple light from the section of first waveguide 202a into the resonator structure 224, and vice versa. Due to the reversed direction of the first waveguide 202a along the coupling section 524, light in the coupling section 524 propagates in a reverse direction relative to the first input signal 240a, such that the light is propagating toward the input end of unit cell 500. In this way, light in waveguide crossing 522 can be coupled into resonator structure 224, which mixes the optical signal from the second waveguide 202b with light from first waveguide 202a. The mixed optical signals can then be supplied back to second waveguide 202b and first waveguide 202a, which propagates downstream to the output end. In examples disclosed herein, propagation losses in the waveguide crossings 522 can be lower than those in a resonator structure, such as resonator structures 224, for example, less than 0.1 dB per crossing.

The electric field transmission matrix (T_{MT_Signle_MRR}) of the example signal mixing components 520 of FIG. 5 is:

$${T}_{MT \_ Sinlge \_ MRR} = [ \begin{matrix}\frac{{t}_{0} - {t}_{0} {ae}^{j θ}}{1 - {at}_{0}^{2} {e}^{j θ}} & \frac{- \sqrt{a} {k}_{0}^{2} {e}^{j θ / 2}}{1 - {at}_{0}^{2} {e}^{j θ}} \\ \frac{- \sqrt{a} {k}_{0}^{2} {e}^{j θ / 2}}{1 - {at}_{0}^{2} {e}^{j θ}} & \frac{{t}_{0} - {t}_{0} {ae}^{j θ}}{1 - {at}_{0}^{2} {e}^{j θ}}\end{matrix} ] \qquad Eq . 3$$

where a is the single round trip amplitude transmission in the resonator structure 224; t is the transmission coefficient, such that to represents a transmission coefficient between second waveguide 202b and resonator structure 224; θ is the phase of the light propagating in the resonator structure 224; j is an imaginary number; and k₀ is the coupling coefficient between second waveguide 202b and resonator structure 224. In this example, the coupling k₀ also represents the coupling coefficient between resonator structure 224 and first waveguide 202a at the coupling section 524. However, in other implementations, the coupling between resonator structure 224 and second waveguide 202b need not be the same as the coupling between resonator structure 224 and coupling section 524.

As described above in connection with FIG. 2, the refractive index of the waveguide forming the resonator structures 224 can be altered through control of the phase θ by utilizing phase shift mechanisms 228. By tuning the resonance, the intensity of light coupled into and out of resonator structure 224 can be adjusted.

FIG. 6 depicts an example of another implementation of a unit cell in accordance with the presently disclosed technology. FIG. 6 provides unit cell 600, which is substantially similar to unit cell 200 except as provided herein. Particularly, similar to unit cell 500 above, unit cell 600 provides a single resonator structure implementation of signal mixing components. Reference numbers in FIG. 6 refer to elements of like reference numbers from FIG. 6 and the description provided in connection with FIG. 2 applies here to like reference numbers in FIG. 6.

For example, unit cell 600 is optically coupled between first waveguide 202a and second waveguide 602b. Second waveguide 602b may be substantively similar to second waveguide 202b, except that second waveguide 602b may include taper 604 and inverse taper 606. Taper 604 increases the width of the second waveguide 602b from a first width to a second width (w_{d}), while the inverse taper 606 decreases the width from the second width to a third width, which may be the same or different from the first width. In various examples, the first and third widths are smaller than the second width (w_{d}). First and second input signals 240a and 240b can be injected into the first and second waveguides 202a and 202b, respectively, and first and second output signals 250a and 250b are output form first and second waveguides 202a and 202b, respectively.

Unit cell 600 comprises a plurality of sub-unit cells, illustratively shown as sub-unit cell 610a and sub-unit cell 610b (individually referred to herein as a sub-unit cell 610 as an illustrative example or collectively referred to herein as sub-unit cells 610). The sub-unit cells 510 each comprise a signal mixing component and a phase tuning component. For example, sub-unit cells 610a and 610b comprise signal mixing component 620a and signal mixing component 620b (individually referred to herein as a signal mixing component 620 as an illustrative example or collectively referred to herein as signal mixing components 620) and phase tuning components 230a and 230b. While two sub-unit cells 610 are shown in FIG. 6, this is for illustrative purposes only. Any number of sub-unit cells 610 may be included in unit cell 600. As described above, the sub-unit cells 610 comprise resonator structures that can be tuned so to configure each sub-unit cell 610 to operate on a distinct wavelength of light, thereby associating a distinct wavelength of light to each sub-unit cell 610.

As noted above, each sub-unit cell 610 comprises phase tuning components 230 and the description of phase tuning components 230 provided in connection with FIG. 2 applies to FIG. 6 as well. Thus, the phase tuning components 230 each comprise a resonator structure 232 and a phase shift mechanisms 234 disposed thereon. Each phase tuning component 230 of a given sub-unit cell 610 can control the phase difference between optical signals, propagating at a wavelength corresponding to the given sub-unit cell 610, on first waveguide 202a and second waveguide 602b.

Each sub-unit cell 610 also comprises a signal mixing component 620, which may be substantively similar to the signal mixing components 220, except as provided herein. For example, signal mixing components 620a and 620b comprise first resonator structures 224a and 224b, respectively, optically coupled to first waveguide 202a and to the second waveguide 602b. FIG. 6 illustrates directional coupler 625a and 625b (individually referred to herein as a directional coupler 625 as an illustrative example or collectively referred to herein as directional couplers 625) implemented to provide for coupling light between a respective resonator structures 224 and second waveguide 602b. Each directional coupler 625 can provide for evanescent coupling of light from second waveguide 602b into a respective resonator structures 224 and vice versa based on the coupling coefficient (k₀) therebetween as well as the resonance frequency of the resonator structures 224. The third width (w_{d}) of second waveguide 602b within the directional coupler 625a (and similarly within directional coupler 625b) may be approximately the same as a width (w_{c}) of the waveguide forming the second resonator structure 224a (and similarly resonator structures 224b). This configuration may assist in coupling due to phase mismatch between optical signals on the second waveguide 602b relative to an optical signal on resonator structure 224.

In the example of FIG. 6, second resonator structure 224a and resonator structures 224b couples to the first waveguide 202a through a contra-directional coupler 623a and a contra-directional coupler 623b (individually referred to herein as a contra-directional coupler 623 as an illustrative example or collectively referred to herein as contra-directional couplers 623), respectively. A contra-directional coupler comprises periodic perturbations over the length L of the coupler. The periodic perturbations are configured to reflect optical signals propagating at one wavelength while transmitting optical signals of other wavelengths. For example, contra-directional coupler 623a may function to reflect an optical signal propagating at the first wavelength corresponding to sub-unit cell 610a and optical signals of other wavelengths to be transmitted downstream. The reflected optical signal is then coupled into resonator structure 224a and propagates in the same direction (e.g., counter clockwise direction) as the optical signal coupled into second resonator structure 224a from second waveguide 602b.

In an example implementation, each contra-directional coupler 623 may comprise a wavelength-specific reflector 621 that comprises a pair of approximately equal-period Bragg gratings respectively coupled to first waveguide 202a and resonator structures 224. The pair of Bragg gratings comprise small-amplitude perturbations (e.g., on the order of tens of micrometers) relative to the widths of the respective waveguide. As shown in FIG. 6, waveguide 202a may have a width wₐ at least within the contra-directional coupler 623a and the waveguide of resonator structure 224a may have a width w_{b} at least within the contra-directional coupler 623a, which may be larger than wₐ. A first Bragg grating 627 may be provided on the waveguide 202a having a grating period A and grating amplitude of h1 (e.g., amplitude perturbations). A second Bragg grating 629 can be provided coupled to the waveguide of second resonator structure 224a having the grating period A (which may be approximately equal to that of grating 627) and grating amplitude of h2 (which may be smaller than h1). The Bragg grating 629 on the resonator structures 224a may function as an anti-reflection grating to suppress Bragg reflections of the grating 627. The grating 629 may be provided out-of-phase relative to the grating 627 (e.g., perturbations of grating 629 aligned with perturbations of grating 627). In an example implementation, wₐ may be 450 nm and w_{b} may be 550 nm, A may be 318 nm, h1 may be approximately 30 nm, and h2 may be approximately 40 nm. However, h2 need not be larger than h1 and may be smaller depending on the application. The length L of each Bragg grating 627 and 629 may be 159 nm and comprise 40 gratings. The period A of each grating determines which wavelengths are reflected, thus controlled selection of the period can be used to tune the wavelength that will be reflected by each Bragg grating pair. While the above example is provided with reference to contra-directional coupler 623a, the other contra-directional coupler 623 may have a substantially similar configuration, except that the period A is selected according to a desired wavelength for each sub-unit cell 610.

The electric field transmission matrix (T_{MT_Signle_MRR}) of the example signal mixing components 620 of FIG. 6 is represented by Eq. 3 above. Thus, as described above in connection with FIG. 2, the refractive index of the waveguide forming the resonator structures 224 can be altered through control of the phase θ by utilizing phase shift mechanisms 228. By tuning the resonance, the intensity of light coupled into and out of resonator structure 224 can be adjusted.

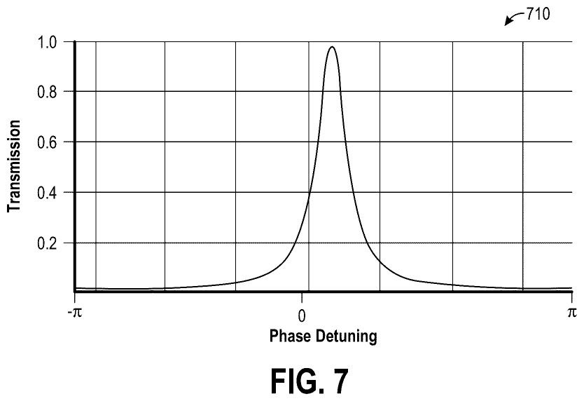

FIG. 7 depicts another example transmission response of a signal mixing component in accordance with an example implementation disclosed herein. FIG. 7 shows a transmission response plot 710 at the output of an example signal mixing component implemented using a single resonator structure, where a normalized transmission is plotted as a function of phase detuning (0) in radians. The signal mixing component may be implemented, for example, as signal mixing components 520 or signal mixing components 620. As can be seen from FIG. 7, signal mixing component can be utilized to achieve any intensity transmission coefficients, from 0 to 1, through phase detuning (e.g., tuning of the resonance frequencies of resonator structures 224, which can be utilized to implement unitary matrix using the unit cell 500 and/or 600.

FIGS. 8A-10B are schematic diagrams of various optical systems that can be utilized to perform various multiplication processes on multiple different matrices in accordance with implementations disclosed herein. FIGS. 8A-10B each comprise an input layer configured to supply an input signal comprising optical signals encoded according to an input matrix; a weight matrix core configured to apply a weight matrix to the input signal, and an output layer configured to detect output signals comprising output optical signal encoded with an output matrix representative of the weight matrix applied to the input matrix.

A feed-forward neural network cascades multiple layers to increase the approximation capability, where information moves in one direction from an input layer to an output layer. For an i^{th} layer, an input and output relationship can be represented as:

$${Y}_{i} = {f}_{i} ( {W}_{i} {X}_{i} ) \qquad Eq . 4$$

where Y represents an i^{th} output matrix; W represents an i^{th} weight matrix; X represents an i^{th} input matrix; and f represents an element-wise nonlinear activation function. In the case of optical devices shown in FIGS. 8-10, elements of Y and X may be encoded into amplitudes of optical signals included in the input signals, such as first and second input signals 140a, first and second input signals 140b, first and second input signals 240a, and first and second input signals 240b. Elements of W may be learned weights to perform a linear transformation on the input matrix X.

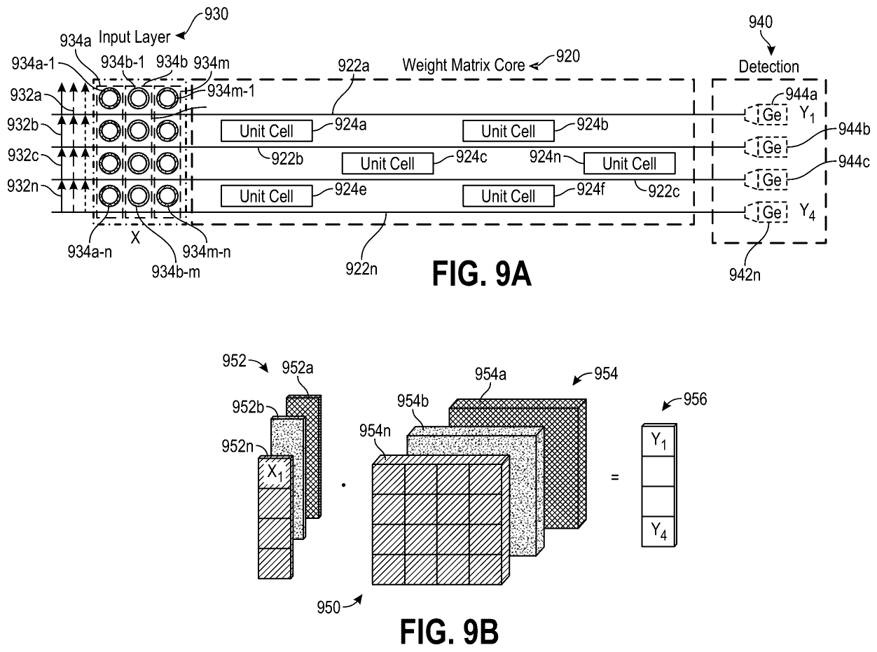

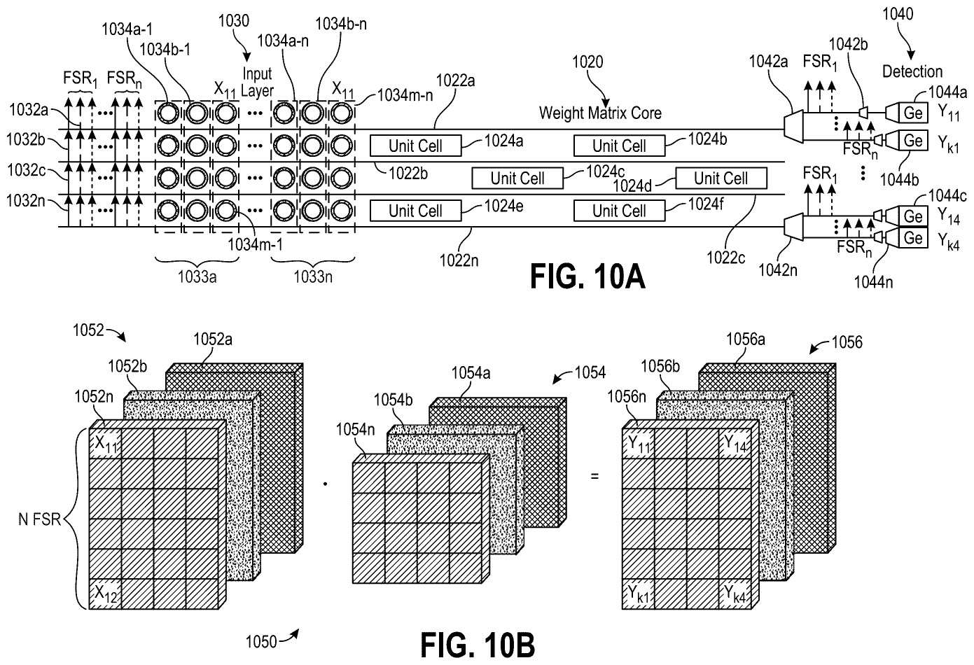

The different configurations shown in FIGS. 8-10 may be utilized to perform various matrix multiplication functions for applying a weight matrix W to an input matrix X. For example, FIG. 8A depicts an optical system 800 for performing multiple matrix-vector multiplication (MVMs) operation 850, shown in FIG. 8B. FIG. 9A depicts an optical system 900 for performing multiple MVMs operation 950 on a set of inputs, as shown in FIG. 9B. FIG. 10A depicts an optical system 1000 for performing one or more general matrix multiplication (GEMM) operations 1050, as shown in FIG. 10B. In each case, the weight matrix core can be implemented by cascading a plurality of unit-cells, such as, unit cells 100 of FIG. 1, unit cell 200 of FIG. 2, unit cell 500 of FIG. 5, and/or unit cell 600 of FIG. 6.

Referring to FIGS. 8A and 8B, MVM operation 850 includes multiplying input vector 852 to a plurality of weight matrices 854. Input vector 852 may be a n×1 vector and weight matrices 854 may be a m set of n×n weight matrices 854a-854n, comprises weight values as entries, to be applied to input vector 852, where m and n are integers greater than zero. Applying weight matrices 854 to input vector 852, results an output vectors 856 that comprises an m set of output vectors 856a-n that are products of each matrix 854a-854n and input vector 852. While three weight matrices are illustrated herein (e.g., m=3), any number of weight matrices may be included in weight matrices 854.

To achieve operation 850, optical system 800 comprises input layer 830 that receives input signals from an optical source (such as a comb laser or other light source as known in the art). The optical source may emit a plurality of input signals 832a-832n onto a plurality of waveguides 822a-822n. Each input signal 832a-832n may comprises an m number of optical signals, each propagating at a distinct wavelength. The number of waveguides 822a-822n may correspond to the number of entries in the input vector 852 and the number of optical signals at distinct wavelengths may correspond to the number of weight matrices 854a-854n.

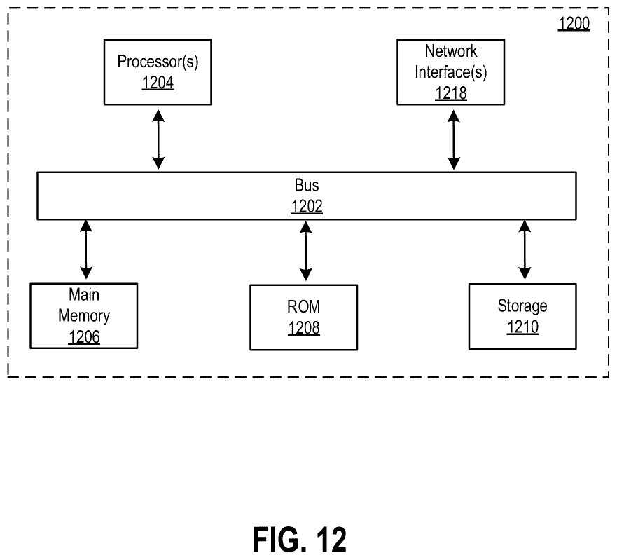

Optical system 800 comprises a plurality of wideband modulators 834a-834n disposed on the plurality of waveguides 822a-822n. The wideband modulators 834a-834n may be configured to modulate the amplitude of input signals 832a-832n according to entries of the input vector 852. For example, wideband modulator 834a may be configured to modulate amplitudes of the optical signals that make up input signal 832a according to a first entry (x₁) of input vector 852. As wideband modulators, wideband modulator 834a can modulate optical signals at each of the distinct wavelengths according to the first entry. Similarly, wideband modulators 834b-n modulate amplitudes of the optical signals included in input signal 832b-832n according to a second through n^{th} entry of input vector 852 (e.g., x₂ through x₄ in this example). Modulating the amplitudes of the optical signals encodes each optical signal with an entry of the input vector 852. The wideband modulators 834a-834n may be implemented as, for example but not limited to, a Mach-Zehnder Modulator, Electro-absorption modulator, or the like. A control circuit 860 may be communicatively coupled (e.g., by a wired or wireless interface) to control the modulators 834a according to the entries of the input vector 852. Control circuit 860 may be implemented as computer system 1200, discussed below in connection with FIG. 12.

The encoded input signals are supplied to a weight matrix core 820 (also referred to as a cross bar array). Weight matrix core 820 comprises a plurality of unit cells 824a-824n arranged in a cascaded structure. The plurality of unit cells 824a-824n may be implemented as any of unit cell 100, unit cell 200, unit cell 500, or unit cell 600. Each unit cell 824a-824n can be tuned according to entries in the weight matrices 854. For example, each unit cell 824a-824n may comprise a m number of sub-unit cells, as described above in connection with FIGS. 1, 2, 5, and 6. Each sub-unit cell, which comprises one or more resonant structures as described above, may be tuned for a distinct wavelength of the m optical signals. Signal mixing components and phase tuning components of sub-unit cell can then be detuned so to apply weights according to entries of the weight matrices 854.

For example, a first set of sub-unit cells of the unit cells 824a-824n may be tuned to a first wavelength, corresponding to weight matrix 854a. The signal mixing components and phase tuning components of the first set of sub-unit cells can be detuned according to entries of weight matrix 854a. Thus, the first set of sub-unit cells can apply the weight matrix 854a to the input vector 852 by modulating the optical signal at the first wavelength encoded with entries of the input vector 852 based on the detuning of the signal mixing components and the phase tuning components. Similarly, a second set of sub-unit cells of the unit cells 824a-824n may be tuned to a second wavelength, corresponding to weight matrix 854b, and an m^{th} set of sub-unit cells of the unit cells 824a-824n may be tuned to an m^{th} wavelength, corresponding to weight matrix 854n. Thus, each unit cell comprises one sub-unit cell of each of the first, second, and m^{th} set of sub-unit cells.

In various examples, control circuit 860 may be utilized to tune the unit cell. For example, control circuit 860 may adjust a voltage bias applied to phase shifting mechanisms coupled the resonator structures of the unit cells 824a-824n. The phase shifting mechanism may be phase shifting mechanisms 226, phase shifting mechanisms 228, and/or resonator structure 232, as discussed above in connection with FIGS. 2, 5, and 6. The control circuit 860 may issue control commands to a voltage source 862 that applies a voltage bias to the phase shifting mechanisms. The voltage bias may be selected to adjust the phase shift mechanism so to alter an effective index of a waveguide coupled to the phase shifting mechanism. By altering the effective index of the waveguide, a resonator structure formed of the waveguide can be tuned to a distinct wavelength of the m optical signals. To implement entries of the weight matrices 854, each phase shifting mechanism can be detuned according to the weight of each entry by adjusting the voltage bias accordingly.

Accordingly, input vector 852 can be multiplied by different sets of weights to obtain a number of outputs. For example, the output signals from the weight matrix core 820 propagate to a detection layer 840 for determining entries of each output vector 856a-856n based on amplitudes of the output signals at each wavelength. In the example shown in FIG. 8A, detection layer 840 comprises a plurality of demultiplexers 842a-842n coupled to a subset of outputs of the waveguides 822a-822n. The number of demultiplexers 842a-842n may be half of the number of waveguides 822a-822n (e.g., half of the number of entries in the input vector 852). Each of the demultiplexers 842a-842n can be configured to filter each wavelength onto separate output waveguides coupled thereto. The demultiplexers 842a-842n may be provided as coarse wavelength division multiplexing (CWDM) demultiplexers that can be implemented as de-interleavers, contra-directional couplers, or the like. Each of the demultiplexers 842a-842n can be operated to separate output signals from into individual output waveguides according to different wavelengths. For example, demultiplexers 842a-842n receive weighted signals from weight matrix core 820 and separate (e.g., filter) each wavelength of light onto a distinct output waveguide. Thus, each optical signal on each output waveguide is indicative of an entry of an output vectors 856 that corresponds to each wavelength.

Detection layer 840 also comprises photodetectors 844a-1 through 844m-n coupled to the demultiplexers 842a-842n. Photodetectors 844a-1 through 844m-n detect the optical signals on a respective output waveguide, where the amplitude of each detected signal is representative of an entry of output vectors 856. For example, demultiplexer 842a is coupled to a first subset of photodetectors 844a-1 through 844m-n. As described above, demultiplexer 842a filters the output from weight matrix core 820 into distinct wavelengths of light, each of which is supplied to one of the photodetectors 844a-1 through 844m-n via a corresponding output waveguide. Thus, photodetector 844a-1 detects an amplitude of light at a first wavelength that is representative of a first entry of output vector 856a, while photodetectors 844b-1 and 844m-1 detect an amplitude of light at a second and an m^{th} wavelength that is representative of the first entries of output vector 856b and output vector 856n, respectively. Similarly, photodetectors 844a-844n detect an amplitude of light at the first wavelength that is representative of a n^{th} entry of output vector 856a, while photodetectors 844b-n and 844m-n detect an amplitude of light at the second and the m^{th} wavelength that is representative of the n^{th} entries of output vector 856b and output vector 856n, respectively.

Accordingly, optical system 800 can used to multiple a plurality of weight matrices 854 to an input vector 852 in parallel (e.g., simultaneously) to determine a plurality of output vectors 856. Thus, an n-port device (e.g. an optical system 800 having an n number of input ports) that can perform any n×n unitary linear transformation can by arranging multiple unit cells 824a-824n in various mesh configurations. Since the resonator structures of the unit cells 824a-824n are narrowband devices, by tuning signal mixers and phase tuning components, different weight matrices can be constructed for each port by leverage multiple wavelengths, as described above. Thus, multiple MVM operations can be performed simultaneously, thereby reducing computation time.

In example implementations, optical system 800 may be utilized for convolutional neural network (CNN) applications. For example, a feature detector implemented as a CNN may include a two-dimensional (2-D) array of weights (e.g., a matrix of weights). A grayscale image used as an input may have a single color channel that defines entries of the input vector 852. Multiple filters for detecting multiple features can be implemented as weights in a weight matrix. Features may be, for example but not limited to, edges, curves, shapes, etc. Thus, each filter may be implemented as a 2-D array of weights, where each 2-D array of weights is implemented as a single weight matrix of weight matrices 854. Each filter can then be applied to the input image using optical system 800 to perform dot products of the input image (e.g., input pixels values) and the multiple filters (e.g., weight matrices 854). Conventionally MZI based ONNs implemented for the above may process one filter at a time. Whereas, the implementations disclosed herein can obtain results for multiple multiplication operations in parallel, which enhances the computation density and reduces computation time.

As alluded to above, FIG. 9A depicts an optical system 900 that can be implemented to perform MVM on a set of input vectors. FIG. 9B depicts the operation 950, whereby a set of m weight matrices 954 is applied to a set of m input vectors 952 to produce an output vector 956, where m is an integer greater than one. The weight matrices 954 comprises a set of m weight matrices 954a-954n and the set of m input vectors comprises input vectors 952a-952n.

To achieve multiple MVMs operation 950, optical system 900 comprises input layer 930 that receives an input signal from an optical source (such as a comb laser or other light source as known in the art). The optical source may emit a plurality of input signals 932a-932n onto a plurality of waveguides 922a-922n. Each source signal 932a-932n may comprises a number m of optical signals, each propagating at a distinct wavelength. The number of waveguides 922a-922n may correspond to the number n of entries in an input vector 952 and the number of optical signals at distinct wavelengths may correspond to the number m of weight matrices 954a-954n.

The input layer 930 comprises a plurality of narrowband modulators 934a-1 through 934m-n, each configured to modulate an amplitude of the input signals 932a-932n at a distinct wavelength according to entries of the input vector 952. By modulating the input signals 932a-932n, entries of the input vectors 952 can be encoded onto the input signals. For example, each input vector 952a-952n may be associated with a distinct wavelength of light (e.g., input vector 952a may correspond to a first wavelength, input vector 952b may correspond to a second wavelength, and input vector 952n may correspond to an m^{th} wavelength). A first subset 934a of narrowband modulators may be configured to modulate light of a first wavelength on each of the source signals 932a-932n according to entries of input vector 952a. A second subset 934b of narrowband modulators may be configured to modulate light of a first wavelength on each of the source signals 932a-932n according to entries of input vector 952b. An m^{th} subset 934m of narrowband modulators may be configured to modulate light of an m^{th} wavelength on each of the source signals 932a-932n according to entries of input vector 952n.

Each waveguide 922a-922n corresponds to each row of the input vectors 952a-952n, such that a given narrowband modulator coupled to a given waveguide modulates an optical signal according to an entry of the row of an input matrix corresponding to the given waveguide, where the modulated optical signal propagates at a wavelength corresponding to the input matrix. That is, for example, narrowband modulate 934a-1 modulates an optical signal at the first wavelength according to a first entry of input vector 952a, narrowband modulate 934b-1 modulates an optical signal at the second wavelength according to a first entry of input vector 952b, and narrowband modulate 934m-1 modulates an optical signal at the m^{th} wavelength according to a first entry of input vector 952n. Similarly, narrowband modulate 934a-n modulates an optical signal at the first wavelength according to a n^{th} entry of input vector 952a, narrowband modulate 934b-n modulates an optical signal at the second wavelength according to a n^{th} entry of input vector 952b, and narrowband modulate 934m-n modulates an optical signal at the m^{th} wavelength according to an n^{th} entry of input vector 952n. Thus, entries of the input vectors 952 can be encoded onto the optical signals divided into separate wavelength channels.

Optical system 900 can comprise a control circuit (not shown in FIG. 9A), such as control circuit 860 of FIG. 8A. The control circuit can be utilized to control the modulators 934a-1 through 934m-n according to the entries of the input vectors 952.

The encoded input signals are supplied to a weight matrix core 920 (also referred to as a cross bar array). Weight matrix core 920 may be substantially similar to weight matrix core 820. As such, weight matrix core 920 comprises a plurality of unit cells 924a-924n, each of which may be implemented as any of unit cell 100, unit cell 200, unit cell 500, or unit cell 600. Each unit cell 924a-924n can be tuned according to entries in the weight matrices 954. For example, each unit cell 924a-924n may comprise a number m of sub-unit cells, as described above in connection with FIGS. 1, 2, 5, and 6. Each sub-unit cell, which comprises one or more resonant structures as described above, may be tuned for a distinct wavelength of the m optical signals. Signal mixing components and phase tuning components of sub-unit cell can then be detuned so to apply weights according to entries of the weight matrices 954. As discussed above, the control circuit can issue control commands for tuning the unit cells 924a-924n according to the entries of the weight matrices 954.

Thus, a set of input matrices 952 can be multiplied by a set of weights to obtain output vector 956. For example, the weighted output signals from the weight matrix core 920 propagate to a detection layer 940 for determining entries of output vector 956 based on amplitudes of the weighted output signals detected by a plurality of photodetectors 944a-944n. Photodetectors 944a through 944n detect the optical signals on a respective waveguide. The optical signals on each waveguide are accumulated at each of the photodetectors 944a-944n and the amplitude detected by each the photodetectors 944a-944n is representative of a respective entry of output vector 956.

According to an example, the maximum number of unit cells to build a N-dimension unitary matrix may be (N−1)*(N/2) unit cells. In an example implementation, an input image may be color image, which can be represented as three input vectors (e.g., input vectors 952) corresponding to the red, green, and blue (RGB) channels of the input image. The weight matrix (e.g., weight matrices 954) may represent weights for each color channel. The weight matrices 954 can be multiplied with each input vector 952, and a summation (e.g., total amplitude on each waveguide) of each output detected at the detection layer 940 provides entries for output vector 956.

For a conventional RGB image, the raw image may include three color channels. A convolutional layer of a neural network can be provided to compute the output of neurons that are connected to local regions in the input, where each computation is a dot product between the weights and the local region of the input image. The weight matrix for each color channel may be unique, and thus implemented as a set of three weight matrices. Each entry in the output vector can be computed by elementwise multiplication of each color channel of a region of the input with a corresponding filter (e.g., weight matrix) and summing up the multiplication. According to this illustrative example, optical system 900 can be configured to achieve all RGB channels convolution within one computation cycle by performing all three color channel computations in parallel. Thus, computation efficiency can be improved by three times compared to conventional MZI-based ONNs.

As alluded to above, FIG. 10A depicts an optical system 1000 that can be implemented to perform GEMM. FIG. 10B depicts the operation 1050, whereby a set of m weight matrices 1054 is applied to a set of m input matrices 1052 to produce a set of m output matrices 1056, where m is an integer greater than zero. In the example of FIG. 10B, the set of m weight matrices 1054 comprises weight matrices 1054a-1054n and the set of m input vectors comprises input matrices 1052a-1052n. Thus, optical system 1000 may be implemented to execute a single GEMM operation (e.g., m=1) or a plurality of GEMM operations (e.g., m>1) in parallel.

In this case, optical system 1000 leverages WDM and multi-FSRs for encoding input matrices 1052 into input signals that can be supplied into a resonator-based weight matrix core 1020. By utilizing WDM and multi-FSRs, optical system 1000 can execute GEMM through parallel photonic processing. Weight matrix core 1020 can be implemented using a plurality of unit cells, such as unit cells 100, 200, 500, and/or 600 discussed above. Weight matrix core 1020 can be encoded with weight matrices 1054, such that when set of input matrices 1052 is input into weight matrix core 1020, set of input matrices 1052 is multiplied with weight matrices 1054 to produce output matrices 1056.

In the illustrative example of FIG. 10A, optical system 1000 comprises input layer 1030 that receives an input signal from an optical source (such as a comb laser or other light source as known in the art). The input signals (shown in FIG. 10 as signals 1032a through 1032n) each can comprise a plurality of optical signals at a plurality wavelength (e.g., an initial resonance wavelength and at least ±(k−1) resonance wavelengths corresponding to multiple FSRs of resonator structures included in the weight matrix core 1020). For example, FIG. 10A depicts a first FSR group (FSR1) through an n^{th} FSR group (FSRn), where the number of FSRs corresponds to a n number of rows in the set of input matrices 1052 (e.g., number of rows in input matrix 1052a, 1052b, or 1052n). Each FSR group comprises an m number of wavelengths corresponding to the number m of input matrices that make up set of input matrices 1052. The first FSR group may correspond to initial resonance wavelengths of resonator structures including the sub-unit cells of weight matrix core 1020, while a second through n^{th} FSR groups correspond to a number n of FSRs of the resonator structure.

Entries of set of input matrices 1052 can be encoded into the plurality of optical signals of input signals 1032a-1032n and the encoded optical signals can be supplied to waveguides 1022a-1022d as inputs into weight matrix core 1020. For example, input layer 1030 comprises a plurality of narrowband modulators that are configured to encode each optical signal with an entry from set of input matrices 1052. For example, input layer 1030 includes a plurality of narrowband modulator groups 1033a-1033n, each corresponding to an FRS group (e.g., narrowband modulator group 1033a corresponds to FSR1 and narrowband modulator group 1033n corresponds to FSRn). Each narrowband modulator group comprises a plurality of sub-groups 1034a-1 through 1034m-n of narrowband modulators. Each sub-group of narrowband modulators comprises a number n of narrowband modulators configured to modulate an optical signal at a wavelength. For example, narrowband modulators of sub-group 1034a-1 are configured to modulate optical signals at a first wavelength and narrowband modulators of sub-group 1034m-1 are configured to modulate optical signals at an m^{th} wavelength, where the first and m^{th} wavelengths are part of FSR1. Whereas, narrowband modulators of sub-group 1034a-n are configured to modulate optical signals at an n^{th} resonance wavelength of the first wavelength and narrowband modulators of sub-group 1034m-n are configured to modulate optical signals at the n^{th} resonance wavelength of the m^{th} wavelength (e.g., FSRn).

Accordingly, entries of each input matrix 1052a-1052n can be encoded into a plurality of optical signals my modulating the optical signals by splitting the signals by both wavelength and FSR groups. For example, each waveguide 1022a-1022n corresponds to a column of the input matrices 1052a-1052n and each FSR group corresponds to a row. Additionally, each wavelength corresponds to an input matrix 1052a-1052n. As such, each narrowband modulator can be controlled to modulate the optical signals according to an entry of input matrix 1052 corresponding to the narrowband modulator.

The encoded optical signals are supplied to the weight matrix core 1020 as input signals. The weight matrix core 1020 may be substantially similar to weight matrix core 1020, and comprises a plurality of unit cells 1024a-1024n implemented as any of unit cell 100, unit cell 200, unit cell 500, or unit cell 600. Each unit cell 1024a-1024n can be tuned according to entries in the weight matrices 1054. For example, each unit cell 1024a-1024n may comprise a number m of sub-unit cells, as described above in connection with FIGS. 1, 2, 5, and 6. Each sub-unit cell, which comprises one or more resonant structures as described above, may be tuned for a distinct wavelength of the m optical signals. As such, resonator structures can operate on at resonance frequency and n number of FSRs. Signal mixing components and phase tuning components of sub-unit cell can then be detuned so to apply weights according to entries of the weight matrices 1054.

Thus, a set of input matrices 1052 can be multiplied by a set of weights to produce a set of output matrices 1056. For example, the weighted output signals from the weight matrix core 1020 propagate to a detection layer 1040 for determining entries of output matrices 1056 based on amplitudes of the weighted output signals detected by a plurality of photodetectors 1044a-1044n. The output from the weight matrix core 1020 is supplied to a set of demultiplexers 1042a-1042n, provided as coarse wavelength division multiplexing (CWDM) demultiplexers that can be implemented as de-interleavers, contra-directional couplers, or the like. Demultiplexers 1042a-1042n can be operated to separate output signals from into individual output waveguides according to different FSR groups. Once separated (e.g., filtered) according to FSR groups, each FSR group can be separated (e.g., filtered) into individual output waveguides according to wavelength included in the respective FSR group (e.g., as shown by demultiplexer 1042b as an example). Photodetectors 1044a through 1044n detect the optical signals for each wavelength on a respective output waveguide. The optical signals on each output waveguide are accumulated at each of the photodetectors 1044a-1044n and the amplitude detected by each the photodetectors 1044a-1044n is representative of a respective entry of output matrices 1056.

Accordingly, by exploiting multiple FSRs of the resonator structures, MVMs of a single photonic core can be extended into GEMM operations as discussed above. In the illustrative example of FIG. 10B, a weight matrices 1054 is provided as a 3×n×n tensor that multiplies with a 3×n×k tensor as set of input matrices 1052, which results in a 3×n×k tensor as output matrices 1056. As discussed above, due to the periodicity of the resonances, each resonator structure in the weight matrix core 1020 has resonances at an initial wavelength (λ₁) and one or more resonance wavelengths corresponding to multiple FSRs resonance (e.g., λ₁+Δλ, . . . , λ₁+(k−1)Δλ, where Δλ is the FSR). By tuning the resonances of the resonator structures, an amount of optical power on each waveguide can be dropped, which multiplies a weight to the optical signal on the waveguide. The response on different FSRs by a resonant structure may be substantively similar, thereby enabling the same weight value to be applied to each resonant wavelength. As discussed above, the input into the weight matrix core 1020 includes vector {x₁₁, . . . , xₙ₁} in column 1 of input matrices 1052 encoded by all the WDM wavelength channels λ₁, λ₁+Δλ, . . . , λ₁+(n−1)Δλ at corresponding input waveguide 1022a-1022n. The depth of the input volumes (e.g., input matrix 1052a and input matrix 1052b) can be parallelly encoded by WDM wavelength channels λ₁, λ₂ and λ₃. The encoded input signals are then weighted as discussed above and selected by demultiplexers 1042a-1042n at each output port. As a result, by encoding the k columns of X into k FSR groups, encoding the 3 depth channels of set of input matrices 1052 in 3 wavelengths, and detecting the different signals at each output port, MVMs between weight matrices 1054 and set of input matrices 1052, e.g., parallelization of GEMM between set of input matrices 1052 and weight matrices 1054, can be implemented in a single device (e.g., optical system 1000).

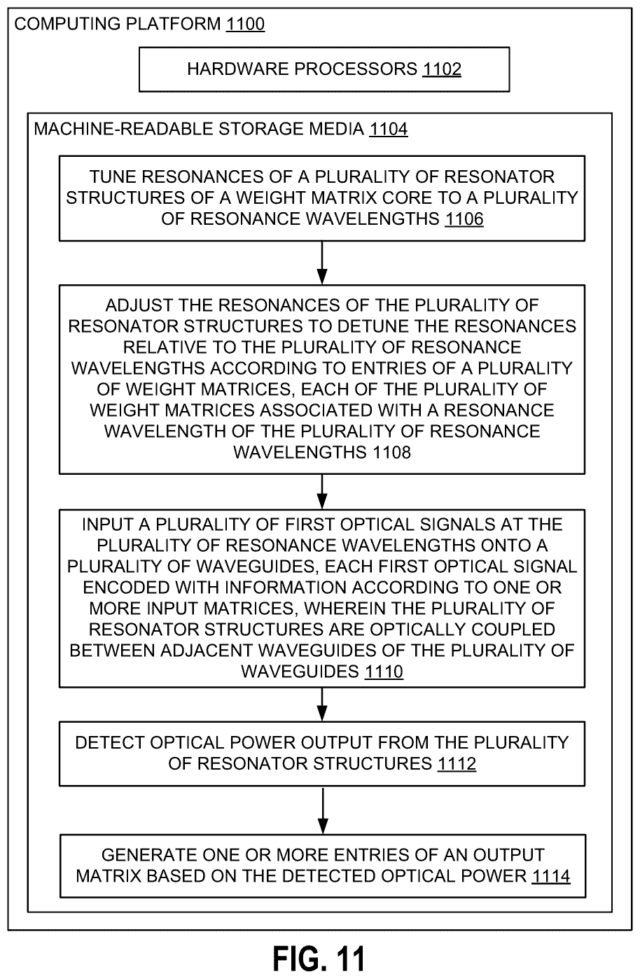

FIG. 11 illustrates an example computing component that may be used to implement an ONN in accordance with various embodiments. Referring now to FIG. 11, computing component 1100 may be, for example, a server computer, a controller, or any other similar computing component capable of processing data. In the example implementation of FIG. 11, the computing component 1100 includes a hardware processor 1102, and machine-readable storage medium for 1104.

Hardware processor 1102 may be one or more central processing units (CPUs), semiconductor-based microprocessors, and/or other hardware devices suitable for retrieval and execution of instructions stored in machine-readable storage medium 1104. Hardware processor 1102 may fetch, decode, and execute instructions, such as instructions 1106-1114, to control processes or operations for ONNs. As an alternative or in addition to retrieving and executing instructions, hardware processor 1102 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1104, may be any electronic, magnetic, optical, or other physical storage device that contains or stores executable instructions. Thus, machine-readable storage medium 1104 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 1104 may be a non-transitory storage medium, where the term “non-transitory” does not encompass transitory propagating signals. As described in detail below, machine-readable storage medium 1104 may be encoded with executable instructions, for example, instructions 1106-1114.

Hardware processor 1102 may execute instruction 1106 to tune resonances of a plurality of resonator structures of a weight matrix core to a plurality of resonance wavelengths. For example, as described above in connection with FIGS. 8A-10B, a weight matrix core may be provided having a plurality of unit cells, such as such as, unit cells 100 of FIG. 1, unit cell 200 of FIG. 2, unit cell 500 of FIG. 5, and/or unit cell 600 of FIG. 6. Each unit cell comprises one or more sub-unit cells comprising one or more resonator structures. A bias (e.g., voltage bias) can be applied to phase shift mechanism, such as phase shifting mechanisms 226, 228, and/or 234, coupled to the resonator structures to tune the resonator structure to a desired resonance frequency (e.g., resonance wavelength).

Hardware processor 1102 may execute instruction 1108 to adjust the resonances of the plurality of resonator structures to detune the resonances relative to the plurality of resonance wavelengths according to entries of a plurality of weight matrices. Each of the plurality of weight matrices may be associated with a resonance wavelength of the plurality of resonance wavelengths. For example, as described, as described above in connection with FIGS. 8A-10B, a plurality of weight matrices may be provided that each comprise entries of learned weights. Each weight matrix may be associated with a resonance wavelength set by the tuning at instructions 1106, such that each unit cell comprises a sub-unit cell that corresponds to a weight matrix. Based on the entries each weigh matrix, the resonance frequencies of the resonator structures of each unit cell can be detuned to act on optical signals encoded with input data according to the weights of the corresponding weight matrix.

Hardware processor 1102 may execute instruction 1110 to input a plurality of first optical signals at the plurality of resonance wavelengths onto a plurality of waveguides, each first optical signal encoded with information according to one or more input matrices. The plurality of resonator structures are optically coupled between adjacent waveguides of the plurality of waveguides into which the plurality of first optical signals are supplied. Example implementations of the first optical signals are provided above in connection with FIGS. 8A-10B, such that the implementations disclosed herein can be used to perform various multiplication processes on various matrices. The plurality of first optical signals can be encoded with data representing entries of a single matrix or vector to perform multiple matrix-vector multiplications on a single input (e.g., FIGS. 8A and 8B). As another example, the plurality of first optical signals can be encoded with data representing entries of a plurality of vectors to perform matrix-vector multiplication operations on the multiple inputs (e.g., FIGS. 9A and 9B). As yet another example, the plurality of first optical signals can be encoded with data representing entries of a set of matrices for performing multiple general matrix multiplication operations (e.g., FIGS. 10A and 10B).

Hardware processor 1102 may execute instruction 1112 to detect optical power output from the plurality of resonator structures. For example, as described in connection with FIGS. 8A-8B, outputs from the weight matrix core can be demultiplexed into separate outputs according to resonance frequency and an optical power detected for each output.

Hardware processor 1102 may execute instruction 1114 to generate one or more entries of an output matrix based on the detected optical power. For example, as described in connection with FIGS. 8A-10B, the detected optical power from instructions 1112 is representative of an entry in a resultant matrix, which can be used to construct an output of the multiplication operations, as described above.

FIG. 12 depicts a block diagram of an example computer system 1200 in which various of the embodiments described herein may be implemented. The computer system 1200 includes a bus 1202 or other communication mechanism for communicating information, one or more hardware processors 1204 coupled with bus 1202 for processing information. Hardware processor(s) 1204 may be, for example, one or more general purpose microprocessors.

The computer system 1200 also includes a main memory 1206, such as a random access memory (RAM), cache and/or other dynamic storage devices, coupled to bus 1202 for storing information and instructions to be executed by processor 1204. Main memory 1206 also may be used for storing temporary variables or other intermediate information during execution of instructions to be executed by processor 1204. Such instructions, when stored in storage media accessible to processor 1204, render computer system 1200 into a special-purpose machine that is customized to perform the operations specified in the instructions.

The computer system 1200 further includes a read-only memory (ROM) 1208 or other static storage device coupled to bus 1202 for storing static information and instructions for processor 1204. A storage device 1210, such as a magnetic disk, optical disk, or USB thumb drive (Flash drive), etc., is provided and coupled to bus 1202 for storing information and instructions.

The computing system 1200 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” “data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl or Python. It will be appreciated that software components may be callable from other components or from themselves, and/or may be invoked in response to detected events or interruptions. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1200 may implement the techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor(s) 1204, executing one or more sequences of one or more instructions contained in main memory 1206. Such instructions may be read into main memory 1206 from another storage medium, such as with storage device 1210. Execution of the sequences of instructions contained in main memory 1206 causes processor(s) 1204 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1210. Volatile media includes dynamic memory, such as main memory 1206. Common forms of non-transitory media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from, but may be used in conjunction with, transmission media. Transmission media participates in transferring information between non-transitory media. For example, transmission media includes coaxial cables, copper wire and fiber optics, including the wires that comprise bus 1202. Transmission media can also take the form of acoustic or light waves, such as those generated during radio-wave and infra-red data communications.

The computer system 1200 also includes a communication interface 1218 coupled to bus 1202. Communication interface 1218 provides a two-way data communication coupling to one or more network links that are connected to one or more local networks. For example, communication interface 1218 may be an integrated services digital network (ISDN) card, cable modem, satellite modem, or a modem to provide a data communication connection to a corresponding type of telephone line. As another example, communication interface 1218 may be a local area network (LAN) card to provide a data communication connection to a compatible LAN (or WAN component to communicated with a WAN). Wireless links may also be implemented. In any such implementation, communication interface 1218 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic or optical signals that carry digital data streams. The signals through the various networks and the signals on network link and through communication interface 1218, which carry the digital data to and from computer system 1200, are example forms of transmission media.

The computer system 1200 can send messages and receive data, including program code, through the network(s), network link and communication interface 1218. In the Internet example, a server might transmit a requested code for an application program through the Internet, the ISP, the local network and the communication interface 1218.

The received code may be executed by processor 1204 as it is received, and/or stored in storage device 1210, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functions can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1200.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period, or to an item available as of a given time, but instead should be read to encompass conventional, traditional, normal, or standard technologies that may be available or known now, or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An optical device for implementing an optical neural network, the optical device comprising:
a plurality of waveguides configured to receive a plurality of first optical signals propagating at a plurality of wavelengths; and
a unit cell disposed between a first waveguide and a second waveguide of the plurality of waveguides, the unit cell configured to perform a linear transformation of each of the first optical signals to output a plurality of second optical signals at a plurality of wavelengths, the unit cell comprising:
a plurality of signal mixing components optically coupled to the first waveguide and the second waveguide of the plurality of waveguides, each signal mixing component corresponding to a distinct wavelength of the plurality of wavelengths and configured to mix first optical signals on the first and second waveguides at the distinct wavelength; and
a plurality of phase tuning components, each phase tuning component of the plurality of phase tuning components corresponding to a distinct wavelength of the plurality of wavelengths configured to adjust a phase of a mixed optical signal at the distinct wavelength of the plurality wavelengths and output a second optical signal of the plurality of second optical signals.

2. The optical device of claim 1, wherein at least one signal mixing component of the plurality of signal mixing components comprises one or more resonator structures and one or more phase shifting mechanisms coupled to the one or more resonator structures, the one or more phase shifting mechanisms adapted to tune a resonance frequency of the one or more resonator structures.

3. The optical device of claim 2, wherein the one or more phase shifting mechanisms comprises at least one of: a resistive heater, PN diode, and a metal-oxide-semiconductor capacitor.

4. The optical device of claim 1, wherein at least one signal mixing component of the plurality of signal mixing components comprises a resonator structure and a phase shifting mechanism coupled to the resonator structure, the phase shifting mechanism adapted to tune a phase of an output of the at least one signal mixing component.

5. The optical device of claim 1, wherein each of the plurality of signal mixing components comprises a serially coupled double ring micro-ring resonator having a first micro-ring resonator optically coupled to the first waveguide and a second micro-ring resonator optically coupled to the first micro-ring resonator and the second waveguide.

6. The optical device of claim 1, wherein each of the plurality of signal mixing components comprises a first micro-ring resonator optically coupled to the first and second waveguides, wherein the first micro-ring resonator is coupled to the second waveguide via a contra-directional coupler.

7. The optical device of claim 1, wherein the second waveguide comprises a plurality of waveguide crossings, and wherein each of the plurality of signal mixing components comprises a first micro-ring resonator optically coupled to the first waveguide and to the second waveguide via a waveguide crossing.

8. The optical device of claim 1, further comprising:
a weight matrix core adapted to apply one or more weight matrices to an input signal, the input signal comprising the first optical signals, the weight matrix core comprising:
a plurality of unit cells disposed between adjacent waveguides of the plurality of waveguides in a cascaded configuration, the plurality of unit cells comprising the unit cell disposed between the first and second waveguide, each of the plurality of unit cells comprising one or more resonator structures tuned according to an entry of the one or more weight matrices.

9. A method for implementing an optical neural network, comprising:
tuning resonances of a plurality of resonator structures of a weight matrix core to a plurality of resonance wavelengths;
adjusting the resonances of the plurality of resonator structures to detune the resonances relative to the plurality of resonance wavelengths according to entries of a plurality of weight matrices, each of the plurality of weight matrices associated with a resonance wavelength of the plurality of resonance wavelengths;
inputting a plurality of first optical signals at the plurality of resonance wavelengths onto a plurality of waveguides, each first optical signal encoded with information according to one or more input matrices, wherein the plurality of resonator structures are optically coupled between adjacent waveguides of the plurality of waveguides;
detecting optical power output from the plurality of resonator structures; and
generating one or more entries of an output matrix based on the detected optical power.

10. The method of claim 9, wherein tuning resonances of a plurality of resonator structures comprises:
applying a plurality of biases to a plurality of phase shifting mechanisms coupled to the plurality of resonator structures.

11. The method of claim 10, wherein adjusting the resonances of a plurality of resonator structures comprises:
adjusting the plurality of biases applied to a plurality of phase shifting mechanisms according to entries of the plurality of weight matrices.

12. The method of claim 9, wherein the weight matrix core comprises a plurality of unit cells and each unit cell comprises a subset of the plurality of resonator structures, and wherein tuning the resonances of a plurality of resonator structures comprises:
tuning the resonances of each resonator structure of each subset resonator structures to the plurality of resonance wavelengths.

13. A weight matrix core, comprising:
a plurality of waveguides each configured to receive a plurality of first optical signals propagating at a plurality of wavelengths and output a plurality of second optical signals; and
a plurality of unit cells provided between adjacent waveguides of the plurality of waveguides, each unit cell comprising a plurality of sub-unit cells each corresponding to a wavelength of the plurality of wavelengths, wherein each sub-unit cell comprises:
a signal mixing component optically coupled to the adjacent waveguide of the plurality of waveguides, the signal mixing component configured to mix a first optical signal on the adjacent waveguides at the wavelength corresponding to the respective sub-unit cell; and
a phase tuning component configured to adjust a phase of a mixed first optical signal at the wavelength corresponding to the respective sub-unit cell and output a second optical signal of the plurality of second optical signals.

14. The weight matrix core of claim 13, wherein the plurality of first optical signals are encoded according to one or more input matrices.

15. The weight matrix core of claim 14, wherein the signal mixing component comprises at least one resonator structure, wherein at least one resonance structure is configured to mix the first optical signal on the adjacent waveguides based on detuning a resonance frequency of the at least one resonator structure.

16. The weight matrix core of claim 14, wherein the phase tuning component comprises a resonator structure that is configured to adjust the phase of the mixed first optical signal based on detuning a resonance frequency of the resonator structure.

17. The weight matrix core of claim 16, wherein detuning the resonance frequency is based on entries of a plurality of weight matrices associated with the plurality of wavelengths.

18. The weight matrix core of claim 13, wherein the signal mixing component comprises a serially coupled double ring micro-ring resonator having a first micro-ring resonator optically coupled to a first waveguide of the adjacent waveguides and a second micro-ring resonator optically coupled to the first micro-ring resonator and a second waveguide of the adjacent waveguides.

19. The weight matrix core of claim 13, wherein the signal mixing component comprises a first micro-ring resonator optically coupled to the adjacent waveguides, wherein the first micro-ring resonator is coupled to one of the adjacent waveguides via a contra-directional coupler.

20. The weight matrix core of claim 13, wherein a first waveguide of the adjacent waveguides comprises a waveguide crossing, and wherein the signal mixing component comprises a first micro-ring resonator optically coupled to a second waveguide of the adjacent waveguides and to the waveguide crossing.
